(19) United States
(12) Patent Application Publication
(10) Pub. No.: US 2024/0269763 A1
(43) Pub. Date: Aug. 15, 2024

(54) DEVICE FOR MEASURING WEAR AMOUNT OF WELDING TIP, CONTROL DEVICE, ROBOT SYSTEM, METHOD, AND COMPUTER PROGRAM

(71) Applicant: Fanuc Corporation, Minamitsuru-gun, Yamanashi (JP)

(72) Inventor: Akinori Nishimura, Minamitsuru-gun, Yamanashi (JP)

(73) Assignee: Fanuc Corporation, Minamitsuru-gun, Yamanashi (JP)

(21) Appl. No.: 18/568,340

(22) PCT Filed: Jun. 24, 2021
(86) PCT No.: PCT/JP2021/024012

§ 371 Date: Dec. 8, 2023

(51) Int. Cl. B23K 11/25; B23K 11/30

(52) U.S. Cl. CPC B23K 11/253; B23K 11/3063

(57) ABSTRACT

A device includes: a measurement operation execution unit that controls a mobile machine to execute a measurement operation for moving a welding tip in a first direction to a measurement location; a location data acquisition unit that acquires the location of the mobile machine when the measurement operation has been executed; and a measurement initiation location determination unit that determines, as a measurement initiation location, a location for the mobile machine at which the welding tip is arranged at a prescribed distance apart from a first location in a second direction, which is opposite of the first direction, based on the first location which is acquired during a first measurement operation. During a second measurement operation, the measurement operation execution unit controls the mobile machine to position the mobile machine at the measurement initiation location and then move the welding tip in the first direction.

### CROSS REFERENCE TO RELATED APPLICATIONS

This is the U.S. National Phase application of PCT/JP2021/024012 filed Jun. 24, 2021, the disclosure of this application being incorporated herein by reference in its entirety for all purposes.

### FIELD OF THE INVENTION

The present disclosure relates to a device for measuring a wear amount of a welding tip, a control device, a robot system, a method, and a computer program.

### BACKGROUND OF THE INVENTION

There is known a device for measuring a wear amount of a welding tip (e.g., Patent Document 1)

### Patent Literature

[PTL 1] JP 2007-268538 A

### SUMMARY OF THE INVENTION

In the related art, a measurement operation to move a welding tip to a predetermined measurement position is performed to measure a wear amount, but it is desired to adjust the time required for the measurement operation.

A device according to an aspect of the present disclosure is configured to measure a wear amount of a welding tip moved by a movement machine, the device including a measurement operation execution section configured to control the movement machine so as to execute a measurement operation to move the welding tip in a first direction to a predetermined measurement position for measuring the wear amount, a position data acquiring section configured to acquire a position of the movement machine when the measurement operation execution section executes the measurement operation, and a measurement start position determination section configured to, based on a first position by the position data acquiring section in a first measurement operation, determine a position of the movement machine, at which the welding tip is arranged more separate towards a second direction opposite the first direction by a predetermined distance than the first position, as a measurement start position. The measurement operation execution section controls the movement machine so as to move the welding tip in the first direction after positioning the movement machine at the measurement start position, in a second measurement operation after the first measurement operation.

A method according to an aspect of the present disclosure is a method of measuring a wear amount of a welding tip moved by a movement machine, the method including: controlling, by a processor, the movement machine so as to execute a measurement operation to move the welding tip in a first direction to a predetermined measurement position for measuring the amount of wear; acquiring, by the processor, a position of the movement machine when executing the measurement operation; based on a first position acquired in a first measurement operation, determining, by the processor, a position of the movement machine, at which the welding tip is positioned more separate towards a second direction opposite the first direction than the first position, as a measurement start position; and controlling, by the processor, the movement machine so as to move the welding tip in the first direction after positioning the movement machine at the measurement start position, in a second measurement operation after the first measurement operation.

According to the present disclosure, the start point of the operation to move the welding tip in the measurement operation can be set as appropriate. As a result, the time required for the measurement operation can be adjusted as appropriate.

### BRIEF DESCRIPTION OF DRAWINGS

FIG. 1 is a diagram of a robot system according to an embodiment.

FIG. 2 is a block diagram of the robot system illustrated in FIG. 1.

FIG. 3 is an enlarged view of a welding gun illustrated in FIG. 1.

FIG. 4 illustrates the robot system illustrated in FIG. 1, and a fixed member for wear amount measurement.

FIG. 5 is a flowchart illustrating a method of measuring the wear amount.

FIG. 6 is a flowchart illustrating an exemplary flow of step S1 in FIG. 5 and step S41 in FIG. 17.

FIG. 7 illustrates a state upon completion of step S11 in FIG. 6.

FIG. 8 illustrates a state where YES is determined in step S13 in FIG. 6.

FIG. 9 is a diagram for explaining a measurement start position.

FIG. 10 is a flowchart illustrating a method of measuring the wear amount.

FIG. 11 is a flowchart illustrating an exemplary flow of step S21 in FIG. 10.

FIG. 12 is a diagram of a robot system according to another embodiment.

FIG. 13 is a block diagram of the robot system illustrated in FIG. 12.

FIG. 14 illustrates a state upon completion of step S11 in FIG. 6 in the robot system illustrated in FIG. 12.

FIG. 15 illustrates a state where YES is determined in step S13 in FIG. 6 in the robot system illustrated in FIG. 12.

FIG. 16 is a diagram for explaining a measurement start position in the robot system illustrated in FIG. 12.

FIG. 17 is a flowchart illustrating another exemplary method of measuring the wear amount.

FIG. 18 illustrates a state where YES is determined in step S13 in FIG. 6.

FIG. 19 is a diagram for describing a measurement start position in the robot system illustrated in FIG. 12.

FIG. 20 is a flowchart illustrating an exemplary flow of step S44 in FIG. 17.

### DETAILED DESCRIPTION OF EMBODIMENTS OF THE INVENTION

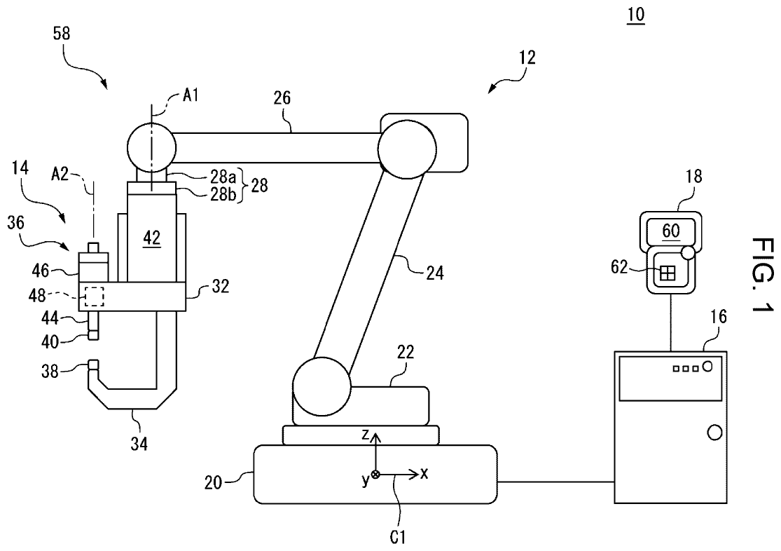

Embodiments of the present disclosure are described in detail below with reference to the drawings. Note that in various embodiments described below, the same elements are denoted with the same reference numerals, and overlapping description is omitted. First, with reference to FIGS. 1 to 3, a robot system 10 according to an embodiment is described. The robot system 10 includes a robot 12, a welding gun 14, a control device 16, and a teaching device 18.

In the present embodiment, the robot 12 is a vertical articulated robot, and includes a robot base 20, a swivel body 22, a lower arm part 24, an upper arm part 26, and a wrist part 28. The robot base 20 is fixed on a floor of a work cell. The swivel body 22 is provided to the robot base 20 so as to be rotatable about the vertical axis.

The lower arm part 24 is provided to the swivel body 22 so as be rotatable about the horizontal axis. The upper arm part 26 is rotatably provided at the distal end portion of the lower arm part 24. The wrist part 28 includes a wrist base 28a rotatably provided at a distal end portion of the upper arm part 26, and a wrist flange 28b provided at the wrist base 28a so as to be rotatable about a wrist axis A1.

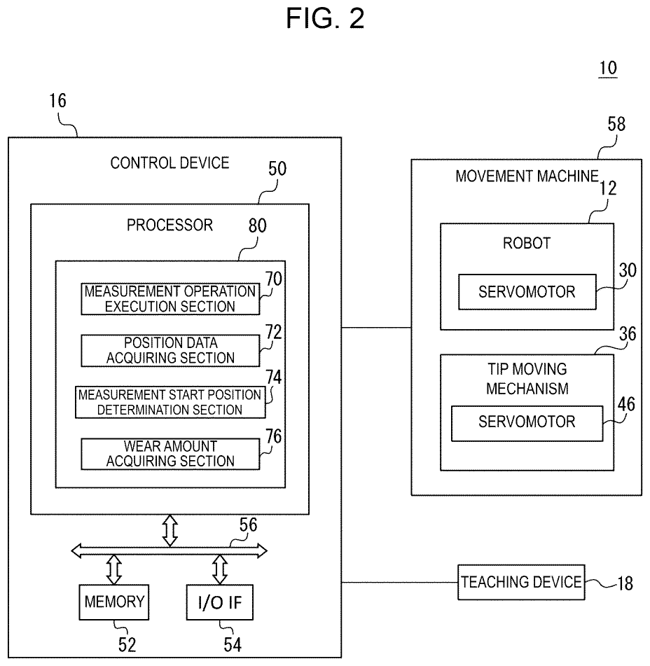

A plurality of servomotors 30 (FIG. 2) are respectively incorporated in the robot base 20, the swivel body 22, the lower arm part 24, the upper arm part 26, and the wrist part 28. The servomotors 30 rotate each movable element of the robot 12 (i.e., the swivel body 22, the lower arm part 24, the upper arm part 26, the wrist part 28, and the wrist flange 28b) in response to a command from the control device 16, thereby moving the welding gun 14.

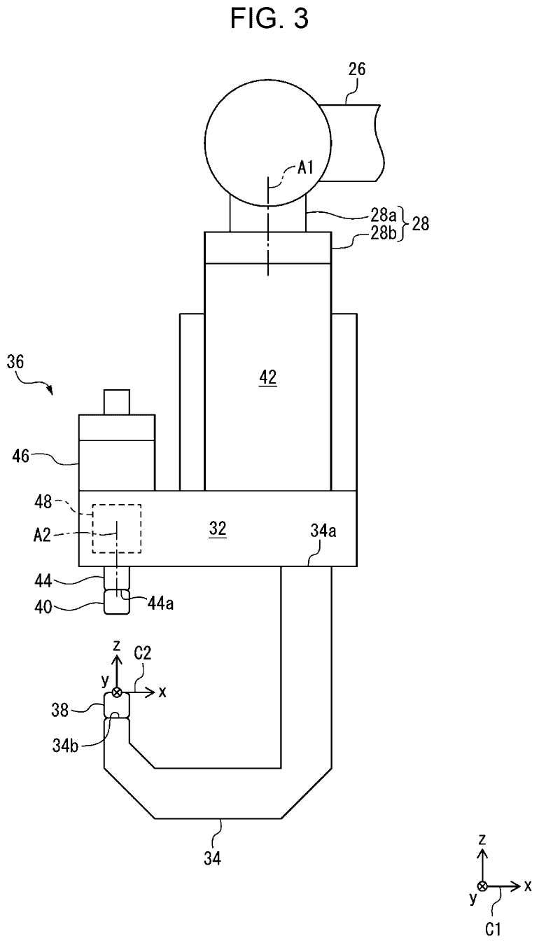

The welding gun 14 is detachably attached to the wrist flange 28b. As illustrated in FIG. 3, in the present embodiment, the welding gun 14 is a so-called C-type spot welding gun, and includes a base part 32, a fixed arm 34, a tip moving mechanism 36, a fixed welding tip 38, and a movable welding tip 40. The base part 32 is coupled to the wrist flange 28b via a supporting member 42. A proximal end 34a of the fixed arm 34 is fixed to the base part 32, and is extended and curved in an L-shape from the proximal end 34a to a distal end 34b.

The tip moving mechanism 36 moves the movable welding tip 40 back and forth along a gun axis A2 in response to a command from the control device 16. More specifically, the tip moving mechanism 36 includes a movable arm 44, a servomotor 46, and a motion conversion mechanism 48. The movable arm 44 is provided at the base part 32 so as to be movable along the gun axis A2. In the present embodiment, the movable arm 44 is a rod-shaped member linearly extending along the gun axis A2.

The servomotor 46 is fixed to the base part 32. The motion conversion mechanism 48 includes a ball screw mechanism, or a mechanism including a timing belt and a pulley, and converts the rotational movement of the output shaft (not illustrated) of the servomotor 46 to a back-and-forth movement along the gun axis A2 of the movable arm 44, for example. The fixed welding tip 38 is fixed to a tip end 34b of the fixed arm 34, whereas the movable welding tip 40 is fixed to a tip end 44a of the movable arm 44. The fixed welding tip 38 and the movable welding tip 40 are arranged so as to be aligned on the gun axis A2.

For welding a workpiece, the tip moving mechanism 36 moves the movable welding tip 40 along the gun axis A2 toward the fixed welding tip 38 by rotationally driving the servomotor 46 in response to a command from the control device 16, and sandwiches the workpiece between the movable welding tip 40 and the fixed welding tip 38. Next, the fixed welding tip 38 and the movable welding tip 40 are energized in response to a command from the control device 16, thereby spot-welding the workpiece sandwiched between the fixed welding tip 38 and the movable welding tip 40.

The control device 16 controls the operation of the robot 12 and the welding gun 14. As illustrated in FIG. 2, the control device 16 is a computer including a processor 50, a memory 52, and an I/O interface 54. The processor 50, including a CPU, a GPU or the like, is communicatively connected to the memory 52 and the I/O interface 54 via a bus 56, and performs arithmetic processing for a wear amount measuring function described later while communicating with these components.

The memory 52 includes a RAM, a ROM or the like, and temporarily or permanently stores various types of data used for the arithmetic processing executed by the processor 50 and various types of data generated during the arithmetic processing. The I/O interface 54 includes an Ethernet (trade name) port, a USB port, an optical fiber connector, or an HDMI (trade name) terminal, and performs data communication with an external device in a wired or wireless manner under a command from the processor 50, for example. In the present embodiment, the servomotors 30 and 46, and the teaching device 18 are communicatively connected to the I/O interface 54.

As illustrated in FIG. 1, a robot coordinate system C1 is set in the robot 12. The robot coordinate system C1 is a coordinate system for automatically controlling each movable element of the robot 12. In the present embodiment, the robot coordinate system C1 is set to the robot 12 such that the origin is arranged at the center of the robot base 20 and the z axis coincides with the turning axis of the swivel body 22. Note that the z axis plus direction of the robot coordinate system C1 is referred to as the upper side for convenience in the following description.

On the other hand, as illustrated in FIG. 3, a tool coordinate system C2 is set in the welding gun 14. The tool coordinate system C2 is a control coordinate system for automatically controlling the position of the welding gun 14 in the robot coordinate system C1. Note that the term “position” as used herein may mean the position and orientation. In the present embodiment, the tool coordinate system C2 is set in the welding gun 14 such that the origin is located on the fixed welding tip 38 (e.g., the center of the tip end surface), and the z axis coincides with (or parallel to) the gun axis A2. The positional relationship between the tool coordinate system C2 and the wrist flange 28b of the robot 12 is known in advance from the information about the dimension of the welding gun 14 and the like.

For moving the welding gun 14, the processor 50 sets the tool coordinate system C2 in the robot coordinate system C1, and operates each movable element of the robot 12 by transmitting a command to each servomotor 30 of the robot 12 so as to position the welding gun 14 at the position represented by the set tool coordinate system C2. In this manner, the processor 50 positions the welding gun 14 at any position of the robot coordinate system C1 through the operation of the robot 12.

In addition, the processor 50 transmits a command to the servomotor 46 of the tip moving mechanism 36, and moves the movable arm 44 (i.e., the movable welding tip 40) along the gun axis A2 through the operation of the tip moving mechanism 36. As described above, in the present embodiment, the movable welding tip 40 is moved through the operation of the robot 12 and the tip moving mechanism 36. Thus, the robot 12 and the tip moving mechanism 36 constitute a movement machine 58 that moves the movable welding tip 40.

As illustrated in FIG. 1, the teaching device 18 is a teach pendant or a mobile computer such as a tablet terminal device, and includes a display section 60 (such as an LCD and an organic EL display), an operation section 62 (such as a push button and a touch sensor), a processor (not illustrated), and a memory (not illustrated), for example.

The operator can perform jog operation of the movement machine 58 by operating the operation section 62 while visually recognizing the image displayed on the display section 60. The operator teaches the movement machine 58 a predetermined operation by performing jog operation of the movement machine 58 by using the teaching device 18, and thus can create an operation program for causing the movement machine 58 to execute the predetermined operation.

Before (or after) the welding work of the welding gun 14, the movable welding tip 40 (and the fixed welding tip 38) may be polished by a polishing machine. This polishing work wears the movable welding tip 40. The processor 50 measures such an amount of wear W of the movable welding tip 40. A method of measuring the amount of wear W is described below.

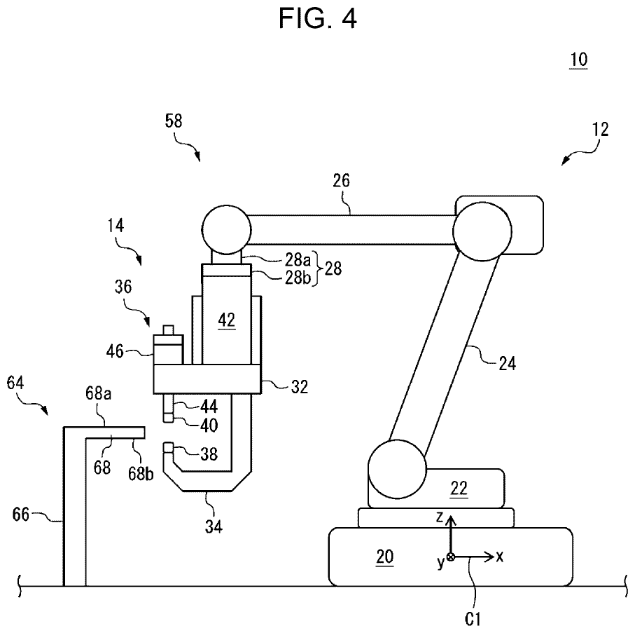

In the present embodiment, the amount of wear W is measured by using a fixed member 64 illustrated in FIG. 4. The fixed member 64 is fixed at a predetermined position in the robot coordinate system C1. More specifically, the fixed member 64 includes a column part 66 extending in the vertical direction, and a contact plate 68 extending in the horizontal direction from the upper end of the column part 66. The contact plate 68 includes a top surface 68a and a bottom surface 68b that are arranged approximately parallel to the x-y plane (i.e., the horizontal plane) of the robot coordinate system C1.

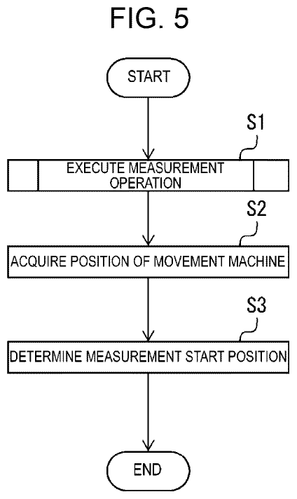

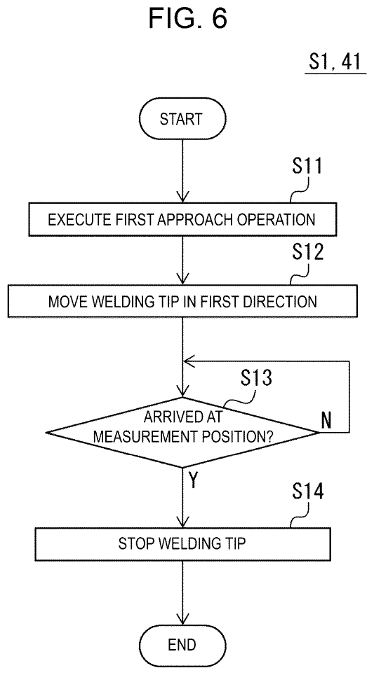

First, the processor 50 executes the flow illustrated in FIG. 5. The flow illustrated in FIG. 5 is started when the processor 50 receives an initial measurement start command CM1 from the operator, a host controller, or the operation program PG. The initial measurement start command CM1 is transmitted when an unworn new movable welding tip 40 is mounted to the movable arm 44. In step S1, the processor 50 executes a first measurement operation MO1. This step S1 is described with reference to FIG. 6.

After the start of step S1, in step S11, the processor 50 executes a first approach operation for positioning the movement machine 58 at a predetermined teaching position TP. More specifically, the processor 50 moves the welding guns 14 by the robot 12 to position the welding gun 14 at a first teaching position TP1, and moves the movable arm 44 at a speed V1 by the tip moving mechanism 36 to arrange the movable arm 44 at a second teaching position TP2. In this manner, in the present embodiment, the teaching position TP of the movement machine 58 includes the first teaching position TP1 where the welding gun 14 is to be positioned by the robot 12, and the second teaching position TP2 where the movable arm 44 is to be positioned by the tip moving mechanism 36.

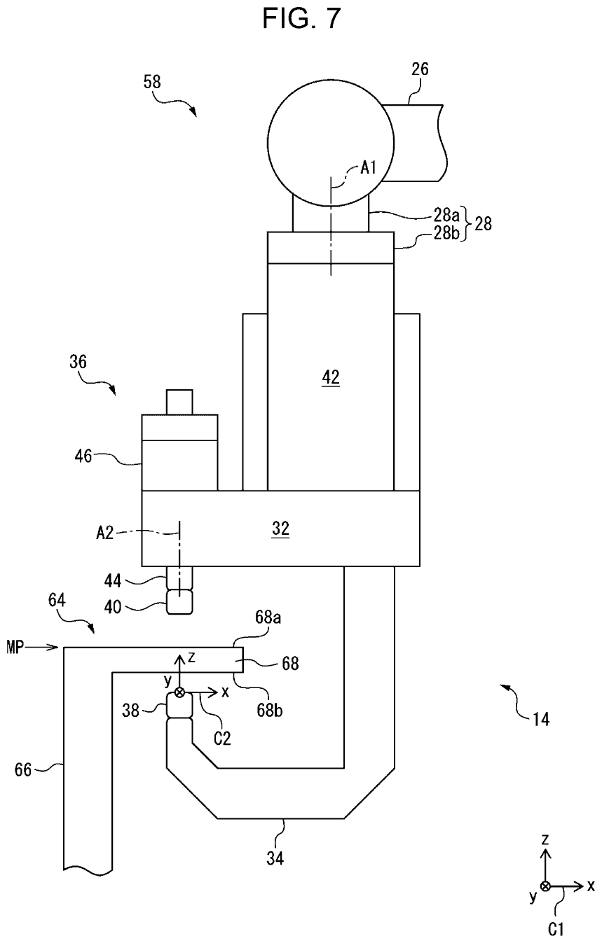

FIG. 7 illustrates a positional relationship between the welding gun 14 and the fixed member 64 when the movement machine 58 is positioned at the teaching position TP. At this time, the contact plate 68 of the fixed member 64 is arranged between the fixed welding tip 38 and the movable welding tip 40, and the movable welding tip 40 is positioned away to the upper side from the top surface 68a of the contact plate 68 by a predetermined distance.

In addition, the fixed welding tip 38 is positioned away to the lower side from the bottom surface 68b of the contact plate 68 by a predetermined distance, and the gun axis A2 is substantially orthogonal to the top surface 68a of the contact plate 68. Note that when the movement machine 58 is positioned at the teaching position TP, the fixed welding tip 38 may come into contact with the bottom surface 68b with no contact force.

The first teaching position TP1 of the robot 12 is set as position data (more specifically, coordinates) representing the position of the tool coordinate system C2 (more specifically, origin position and the direction of each axis) illustrated in FIG. 7. In addition, the second teaching position TP2 of the tip moving mechanism 36 is determined as a rotation position (or rotation angle) of the servomotor 46.

For example, the operator may teach the robot 12 an operation to position the welding gun 14 at the position illustrated in FIG. 7 by operating the teaching device 18 to cause the robot 12 to perform a jog operation, thereby acquiring position data of the first teaching position TP1. The position data of the teaching position TP (the first teaching position TP1 and the second teaching position TP2) is stored in the memory 52 in advance.

With reference to FIG. 6 again, in step S12, the processor 50 moves the movable welding tip 40 toward a measurement position MP in the first direction. In the present embodiment, the measurement position MP is a position of the top surface 68a of the contact plate 68. The processor 50 moves the movable arm 44 forward from the second teaching position TP2 at a speed V2 by operating the tip moving mechanism 36, and thus moves the movable welding tip 40 downward (first direction) at the speed V2. Here, the speed V2 is set to a speed lower than the above-described speed V1 (V2<V1).

In step S13, the processor 50 determines whether or not the movable welding tip 40 has reached the measurement position MP. More specifically, the processor 50 determines whether or not a load torque τ of the servomotor 46 has exceeded a predetermined threshold value τₜₕ. After the start of step S12, the tip end of the movable welding tip 40 comes into contact with the top surface 68a of the contact plate 68, and thus the movable welding tip 40 is arranged at the measurement position MP (i.e., the position of the top surface 68a).

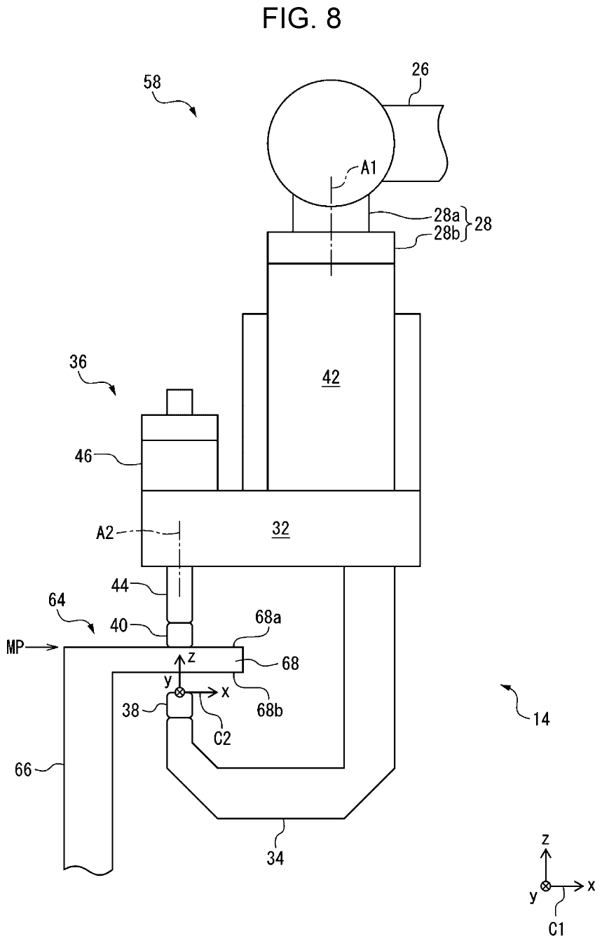

FIG. 8 illustrates a state where the movable welding tip 40 is arranged at the measurement position MP. When the tip end of the movable welding tip 40 comes into contact with the top surface 68a, the load torque τ applied to the servomotor 46 increases. Thus, by monitoring the load torque τ, whether or not the movable welding tip 40 has reached the measurement position MP (i.e., whether or not it has come into contact with the top surface 68a) can be determined.

As an example, the processor 50 may acquire a feedback current from the servomotor 46 as the load torque τ. As another example, the welding gun 14 may further include a torque sensor for detecting the torque applied to the output shaft of the servomotor 46, and the processor 50 may acquire the detection value of the torque sensor as the load torque τ.

In this step S13, when the load torque τ has exceeded the threshold value τₜₕ (τ≥τₜₕ), the processor 50 determines that the movable welding tip 40 has reached the measurement position MP (i.e., YES), and proceeds to step S14. On the other hand, when τ<τₜₕ holds, the processor 50 determines it to be NO, and repeats step S13.

In step S14, the processor 50 stops the movable welding tip 40 by stopping the servomotor 46. Then, the processor 50 terminates step S1, and proceeds to step S2 in FIG. 5. Through this step S1, the movable welding tip 40 is arranged in a stationary manner at the measurement position MP (the top surface 68a).

As described above, in the present embodiment, in the first measurement operation MO1, the processor 50 positions the movement machine 58 at the teaching position TP in step S11, and then controls the movement machine 58 so as to move the movable welding tip 40 downward by the tip moving mechanism 36 in step S12. Thus, the processor 50 functions as a measurement operation execution section 70 (FIG. 2) that controls the movement machine 58 so as to execute measurement operation MO.

With reference to FIG. 5 again, in step S2, the processor 50 acquires a position P₁ of the movement machine 58. More specifically, the processor 50 acquires the rotation position (or rotation angle) of the servomotor 46 upon completion of step S1, as position data representing the position P₁ of the movable arm 44 of the movement machine 58. As an example, the welding gun 14 may further include a rotation detector (such as an encoder or a Hall element) that detects the rotation position of the servomotor 46, and the processor 50 may acquire the detection value of the rotation detector as the position P₁.

As another example, the welding gun 14 may further include a position detector (linear scale, or displacement sensor and the like) that detects the position of the movable arm 44 in the gun axis A2 direction, and the processor 50 may acquire the detection value of the position detector as the position P₁. In this manner, in the present embodiment, the processor 50 functions as a position data acquiring section 72 (FIG. 2) that acquires the position P₁ of the movement machine 58.

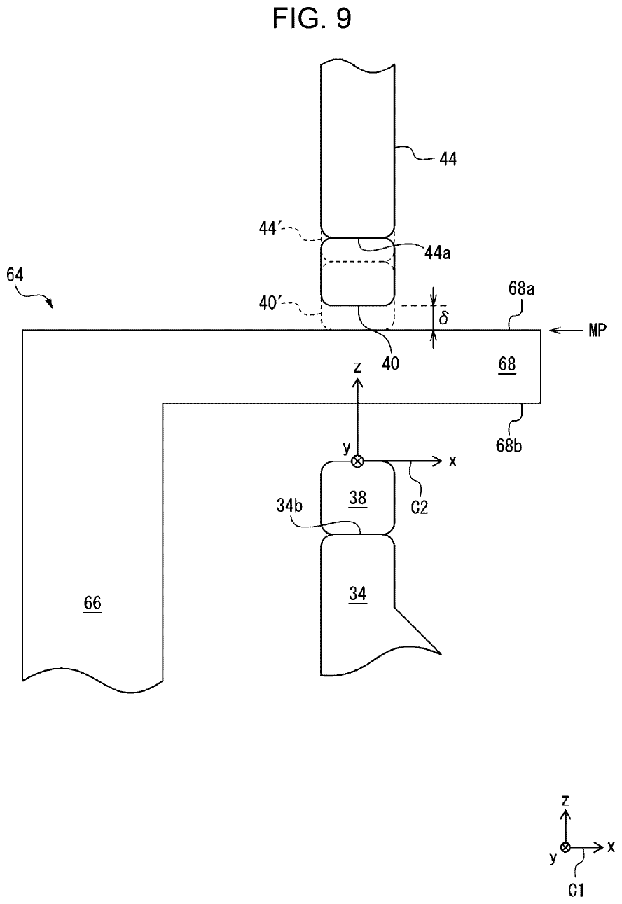

In step S3, the processor 50 determines a measurement start position SP₁ based on the position P₁ acquired in step S2. The measurement start position SP₁ is described below with reference to FIG. 9. In FIG. 9, a dotted line 44′ indicates the movable arm 44 arranged at the position P₁ in step S1, and a dotted line 40′ indicates the movable welding tip 40 (i.e., the measurement position MP) when the movable arm 44 is arranged at the position P₁.

On the other hand, in FIG. 9, the solid line indicates the movable arm 44 arranged at the measurement start position SP₁, and the movable welding tip 40 when the movable arm 44 is arranged at the measurement start position SP₁. As illustrated in FIG. 9, when the movable arm 44 is arranged at the measurement start position SP₁, the movable welding tip 40 is arranged at a position away to the upper side by a predetermined distance δ than when the movable arm 44 is arranged at the position P₁, while the movable welding tip 40 is arranged at a position away to the lower side than when the movable arm 44 is arranged at the second teaching position TP2 (FIG. 7).

Based on the position P₁ acquired in step S2, the processor 50 determines the measurement start position SP₁ as the position of the movable arm 44 at which the movable welding tip 40 is positioned away to the upper side by the distance δ than when the movable arm 44 is arranged at the position P₁. As an example, the distance δ is determined based on a positioning error α in the positioning of the movable welding tip 40 by the movement machine 58. The positioning error α is a distance by which the movable welding tip 40 is displaced from the target position when the movement machine 58 positions the movable welding tip 40 at a predetermined target position, and can be represented by a numerical range ±α (e.g., α=0.1 [mm]).

For example, the processor 50 sets the distance δ as a value (δ=α) matching the positioning error α, and determines the measurement start position SP₁ of the movable arm 44 as a position away to the upper side from the position P₁ by the distance δ=α. Alternatively, the processor 50 may set the distance δ as a value (δ=κα) obtained by multiplying the positioning error α by a predetermined coefficient κ. In this manner, in the present embodiment, the processor 50 functions as a measurement start position determination section 74 (FIG. 2) that determines the measurement start position SP.

After the flow of FIG. 5 is executed, the processor 50 repeatedly performs a series of work of moving welding tips 38 and 40 by the movement machine 58, spot-welding a welding portion on a workpiece (not illustrated) by the welding tips 38 and 40, and then polishing the welding tip 40 (and the welding tip 38).

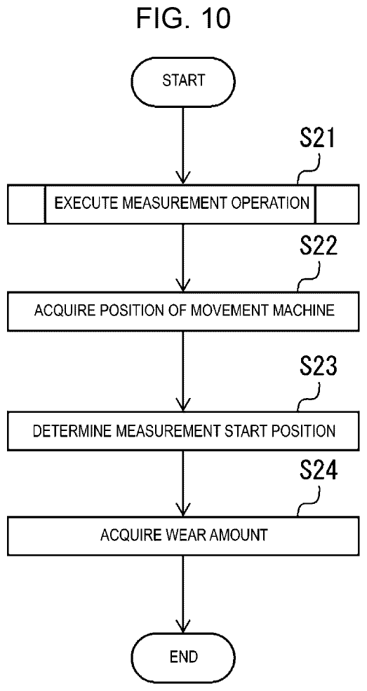

During this series of work, the processor 50 executes the flow illustrated in FIG. 10 for each execution of polishing work. The flow illustrated in FIG. 10 is started when the processor 50 receives a measurement start command CM2 from the operator, a host controller, or the operation program PG. This measurement start command CM2 may be issued for each execution of the polishing work on the welding tips 38 and 40.

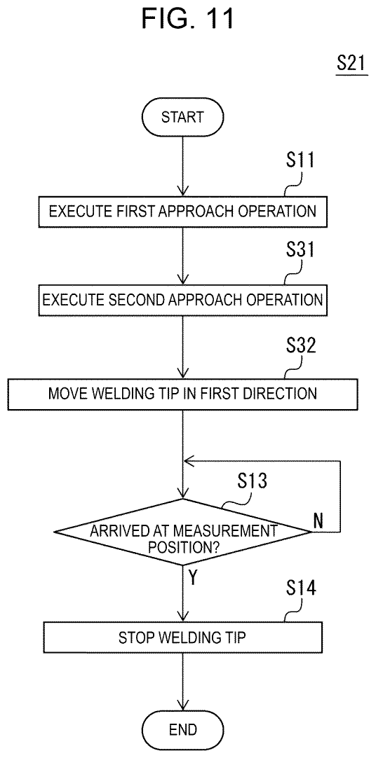

In step S21, the processor 50 functions as the measurement operation execution section 70, and executes an n-th measurement operation MOₙ (n=2, 3, 4, . . . ). Step S21 is described with reference to FIG. 11. Note that in the flow illustrated in FIG. 11, the same processes as those of the flow illustrated in FIG. 6 are denoted with the same step numbers, and overlapping description thereof is omitted.

After the start of step S21, the processor 50 executes the above-described step S11, and positions the movement machine 58 at the teaching position TP illustrated in FIG. 7. In step S31, the processor 50 executes a second approach operation. More specifically, the processor 50 operates the tip moving mechanism 36 to move the movable arm 44 from the second teaching position TP2 to a most recently determined measurement start position SPₙ₋₁ at a speed V3.

For example, when the flow illustrated in FIG. 10 is executed after the flow of illustrated in FIG. 5, the number “n” representing the n-th measurement operation MOₙ is n=2, and the most recently determined measurement start position SPₙ₋₁ indicates the above-described measurement start position SP₁. Thus, at this step S31, the processor 50 moves the movable arm 44 from the second teaching position TP2 to the measurement start position SP₁. Note that the speed V3 of the movement of the movable arm 44 at this step S31 may be set to the same value as that of the above-described speed V1, or to a value different from the speed V1. In addition, the speed V3 may be set to a value greater than that of the above-described speed V2.

In step S32, the processor 50 moves the movable welding tip 40 toward the measurement position MP in a first direction. More specifically, the processor 50 operates the tip moving mechanism 36 to move the movable arm 44 forward from the measurement start position SPₙ₋₁ at a speed V4, thereby moving the movable welding tip 40 downward at a speed V4. This speed V4 is set to a value smaller than that of the above-described speeds V1 and V3 (V4<V1, V4<V3). Note that the speed V4 may be set to the same value as that of the above-described speed V2.

In this manner, at this step S32, the processor 50 controls the movement machine 58 (the tip moving mechanism 36) such that after positioning the movement machine 58 (the movable arm 44) at the measurement start position SPₙ₋₁, the movable welding tip 40 is moved downward. After step S32, the processor 50 sequentially executes the above-described steps S13 and S14.

As described above, by executing steps S11, S31, S32, and S13, the processor 50 moves the movable arm 44 (i.e., the movable welding tip 40) along the gun axis A2 from the second teaching position TP2 (FIG. 7) to the measurement start position SPₙ₋₁ (e.g., the position of a solid line 40 in FIG. 9) at the speed V3, and thereafter moves it from the measurement start position SPₙ₋₁ to the measurement position MP (the position illustrated in FIG. 8) at the speed V4 (<V3).

With reference to FIG. 10 again, in step S22, the processor 50 functions as the position data acquiring section 72 and acquires a position Pₙ (more specifically, the rotation position of the servomotor 46) of the movement machine 58 (more specifically, the movable arm 44) upon completion of step S21 as in the above-described step S2.

In step S23, the processor 50 functions as the measurement start position determination section 74 to determine the measurement start position SPₙ. More specifically, as in the above-described step S3, based on the position Pₙ acquired in the most recent step S22, the processor 50 determines the measurement start position SPₙ as the position of the movable arm 44 at which the movable welding tip 40 is positioned away to the upper side by the distance δ than when the movable arm 44 is arranged at the position Pₙ, whereas the movable welding tip 40 is positioned away to the lower side than when the movable arm 44 is arranged at the second teaching position TP2 (FIG. 7) (see FIG. 9).

In step S24, the processor 50 acquires the amount of wear W. More specifically, based on the position Pₙ₋₁ (first position) acquired by executing an n−1th measurement operation MOₙ₋₁ and the position Pₙ (second position) acquired by executing the n-th measurement operation MOₙ, the processor 50 acquires an amount of wear Wₙ₋₁ caused in the polishing work executed between the n−1th measurement operation MOₙ₋₁ and the n-th measurement operation MOₙ.

For example, when the flow illustrated in FIG. 10 is executed after the flow illustrated in FIG. 5, n=2 holds, and thus the processor 50 acquires, in this step S24, the amount of wear W₁ caused between the first measurement operation MO₁ and a second measurement operation MO₂ based on the above-described position P₁ acquired in step S2 and the position P₂ acquired in the most recent step S22.

As an example, the processor 50 acquires the amount of wear Wₙ₋₁ by calculating a difference Δ_{RP} (=RPₙ−RPₙ₋₁) between a rotation position RPₙ₋₁ of the servomotor 46 acquired as the position Pₙ₋₁ and a rotation position RPₙ of the servomotor 46 acquired as the position Pₙ, and converting the difference Δ_{RP} into a displacement amount in the gun axis A2 direction.

In this manner, in the present embodiment, the processor 50 functions as a wear amount acquiring section 76 (FIG. 2) that acquires the amount of wear Wₙ₋₁ based on the positions Pₙ₋₁ and Pₙ. Thereafter, the processor 50 repeatedly executes the flow of FIG. 10 each time the measurement start command CM2 is received (i.e., each time the polishing work is performed) in the series of the welding work and the polishing work.

Note that the processor 50 may automatically execute the flow illustrated in FIGS. 5 and 10 in accordance with the operation program PG. The operation program PG is a computer program including various commands (e.g., commands for the servomotors 30 and 46) to cause the processor 50 to execute the flows illustrated in FIGS. 5 and 10.

The operation program PG may be provided in a manner recorded in a computer-readable recording medium (the memory 52) such as a semiconductor memory, a magnetic recording medium, or an optical recording medium. The operation program PG is created by the operator by using the teaching device 18, and stored in the memory 52 in advance, for example.

As described above, in the present embodiment, the processor 50 functions as the measurement operation execution section 70, the position data acquiring section 72, the measurement start position determination section 74, and the wear amount acquiring section 76, and measures the amount of wear W. In this manner, the measurement operation execution section 70, the position data acquiring section 72, the measurement start position determination section 74, and the wear amount acquiring section 76 constitutes a device 80 that measures the amount of wear W (FIG. 2). The device 80 (the measurement operation execution section 70, the position data acquiring section 72, the measurement start position determination section 74, and the wear amount acquiring section 76) is a function module that is achieved by the computer program (e.g., the operation program PG) executed by the processor 50.

In the present embodiment, based on the position Pₙ₋₁ (first position) acquired by the n−1th measurement operation MOₙ₋₁, the processor 50 determines the measurement start position SPₙ₋₁ (step S3 or S23), and moves the movable welding tip 40 downward (first direction) after positioning the movement machine 58 (the movable arm 44) at the measurement start position SPₙ₋₁ in the n-th measurement operation MOₙ (steps S31 and S32).

As described above, by determining the measurement start position SPₙ each time, the start point of the operation to move the movable welding tip 40 to the measurement position MP at the speed V4 in the measurement operation MOₙ can be set as appropriate. As a result, the time required for the measurement operation MOₙ can be adjusted as appropriate.

In addition, the processor 50 determines the measurement start position SPₙ₋₁ as the position of the movement machine 58 at which the movable welding tip 40 is arranged away to the upper side (on the second direction side) from the position Pₙ₋₁ by the distance δ. With this configuration, when the movement machine 58 is positioned at the measurement start position SPₙ₋₁ in the second approach operation of the n-th measurement operation MOₙ, the movable welding tip 40 can be positioned away to the upper side from the measurement position MP (the top surface 68a) by the distance of the sum (δ+Wₙ₋₁) of the distance δ and the amount of wear Wₙ₋₁. Thus, it is possible to prevent the movable welding tip 40 from reaching the measurement position MP (i.e., from coming into contact with the top surface 68a) in the second approach operation.

In addition, in the present embodiment, in the measurement operation MOₙ, the processor 50 moves the movable welding tip 40 downward until it comes into contact with the fixed member 64 (more specifically, the top surface 68a) arranged at the measurement position MP, and acquires the position Pₙ of the movement machine 58 when the movable welding tip 40 comes into contact with the fixed member 64 at the measurement position MP.

With this configuration, the movement machine 58 (the movable arm 44) can be reliably stopped by bringing the movable welding tip 40 into contact with the top surface 68a, and the reproducibility of the operation to bring the movable welding tip 40 into contact with the fixed member 64 by the movement machine 58 is high, and thus, the amount of wear Wₙ can be stably acquired with high accuracy.

In addition, in the present embodiment, in the n-th measurement operation MOₙ, the processor 50 positions the movement machine 58 at the teaching position TP (the first approach operation), and thereafter positions it at the measurement start position SPₙ₋₁ (the second approach operation). At this time, the processor 50 moves the movement machine 58 (the movable arm 44) from the teaching position TP to the measurement start position SPₙ₋₁ at the speed V3 (first speed), and thereafter moves it downward from the measurement start position SPₙ₋at the speed V4 (second speed) lower than the speed V3 (step S32).

Here, in the present embodiment, whether the load torque τ of the servomotor 46 has exceeded the threshold value τₜₕ or not is determined in step S13, and the movable arm 44 is stopped in step S14. However, due to delay of the torque response of the servomotor 46 and the like, the stop position of the movable arm 44 in step S14 may vary.

To correctly measure the amount of wear W while suppressing such a variation, it is necessary to set the speed at which the welding tip 40 reaches the measurement position MP in the measurement operation MO to relatively low. In the related art, each time the measurement operation MO is executed, the movement machine 58 is positioned at the teaching position TP taught in advance, and then the movable welding tip 40 is moved from the teaching position TP to the measurement position MP at the relatively low speed V4.

According to the present embodiment, the movable welding tip 40 can be moved by the second approach operation to the measurement start position SPₙ₋₁ at the relatively high speed V3, and thus the time required for the measurement operation MOₙ can be reduced in comparison with the known art. Thus, the work efficiency can be improved by reducing the cycle time of the work. In addition, by moving the movable welding tip 40 from the measurement start position SPₙ₋₁ to the measurement position MP at the relatively low speed V4, the position Pₙ of the movement machine 58 at the time when the movable welding tip 40 reaches the measurement position MP can be correctly acquired, and thus the amount of wear Wₙ can be acquired with high accuracy.

In addition, in the present embodiment, the processor 50 determines the measurement start position SPₙ₋₁ as the position of the movement machine 58 (the movable arm 44) at which the movable welding tip 40 is positioned away to the lower side from the teaching position TP (the second teaching position TP2). With this configuration, the operation of the movable welding tip 40 in steps S31 and S32 is an operation in one axis (the gun axis A2) direction.

Therefore, steps S31 and S32 can be executed through the operation of the movable arm 44 that is movable in one axis direction, and thus the operation program PG for the measurement operation MOₙ and the structure of the movement machine 58 can be simplified. In addition, the position Pₙ of the movable arm 44 of one axis can be detected with high accuracy by the rotation detector provided in the servomotor 46, and thus the amount of wear Wₙ can be detected with high accuracy.

In addition, in the present embodiment, in the n−1th measurement operation MOₙ₋₁ (e.g., the first measurement operation MO₁), the movement machine 58 is positioned at the teaching position TP, and thereafter the movable welding tip 40 is moved downward (in step S11 in FIG. 6 or 11). With this configuration, the common teaching position TP is used in the first approach operation executed in each measurement operation MOₙ, and thus the operation program PG for the measurement operation MOₙ can be simplified.

Note that the processor 50 may control the movement machine 58 (more specifically, the tip moving mechanism 36) so as to move the movable arm 44 downward in step S32 after once stopping the movable arm 44 upon completion of step S31 in FIG. 11 (i.e., when the movable arm 44 is arranged at the measurement start position SPₙ₋₁).

In this case, the above-described distance δ may be determined based on an approach run distance β required for the tip moving mechanism 36 to accelerate the speed V of the movable arm 44 from zero to the speed V4 in step S32. For example, the distance δ may be determined as a value equal to the approach run distance β (δ=β), or a value obtained by multiplying the approach run distance β by a predetermined coefficient κ (δ=κβ). In this case, the processor 50 determines the measurement start position SPₙ to be a position away to the upper side from the position Pₙ by the distance δ (=β or κβ) in steps S3 and S23.

Alternatively, upon completion of the above-described step S31, the processor 50 may continuously execute step S32 without stopping the movable arm 44. In this case, after (or before) arranging the movable arm 44 at the measurement start position SPₙ₋₁ in step S31, the processor 50 reduces the speed V of the movable arm 44 from the speed V3 to the speed V4, and executes step S32.

In this case, the above-described distance δ may be determined based on an approach run distance ε required for the tip moving mechanism 36 to decelerate the movable arm 44 from the speed V3 to the speed V4. For example, the distance δ may be determined as a value equal to the approach run distance ε (δ=ε), or a value obtained by multiplying the approach run distance ε by a predetermined coefficient κ (δ=κε).

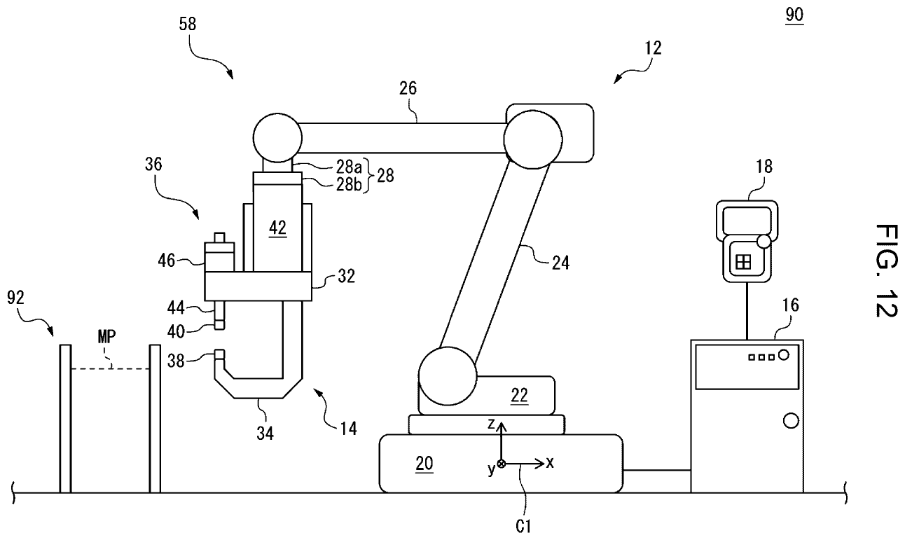

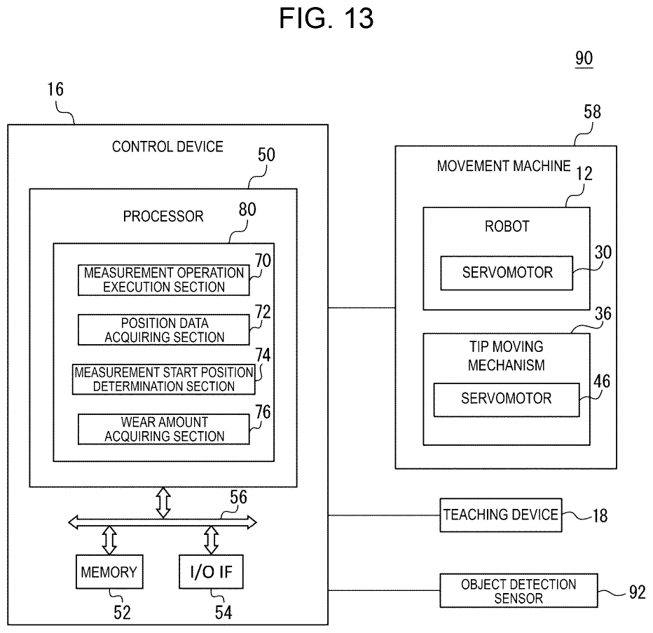

Next, with reference to FIGS. 12 and 13, a robot system 90 according to another embodiment is described. The robot system 90 is different from the above-described robot system 10 in that the robot system 90 further includes an object detection sensor 92. The object detection sensor 92 is communicatively connected to the I/O interface 54 of the control device 16. The object detection sensor 92 emits electromagnetic waves (such as infrared rays) at the measurement position MP, and detects in a noncontact manner the object passing through the measurement position MP. When the object is detected at the measurement position MP, the object detection sensor 92 transmits an object detection signal to the control device 16.

The control device 16 (more specifically, the processor 50) of the robot system 90 measures the amount of wear W by executing the flows illustrated in FIGS. 5 and 10, for example. The following describes processes different from the above-described robot system 10 in the flows of FIGS. 5 and 10 executed by the processor 50 of the robot system 90.

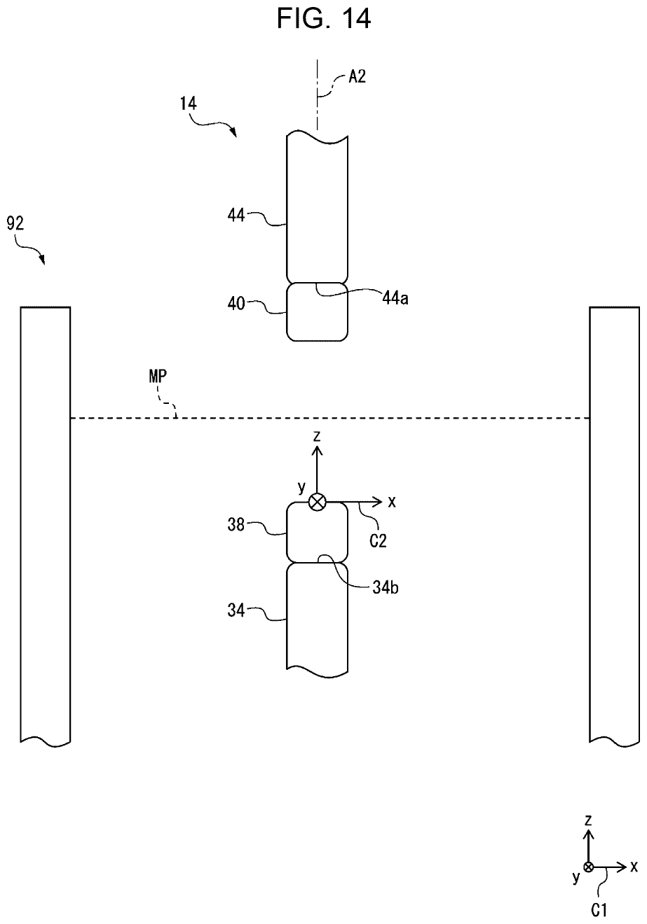

In step S11 in FIG. 6 or 11, the processor 50 of the robot system 90 executes the first approach operation to position the movement machine 58 at the predetermined teaching position TP. FIG. 14 illustrates a positional relationship between the welding gun 14 and the object detection sensor 92 when the movement machine 58 is positioned at the teaching position TP in the present embodiment.

In the example illustrated in FIG. 14, the movable welding tip 40 is positioned away to the upper side from the measurement position MP of the object detection sensor 92 by a predetermined distance, and the gun axis A2 is substantially orthogonal to the measurement position MP (the propagation direction of the electromagnetic waves emitted by the object detection sensor 92). The processor 50 moves the welding gun 14 by the robot 12 to position it at the first teaching position TP1 represented by the tool coordinate system C2 illustrated in FIG. 14, and moves the movable arm 44 at the speed VI by the tip moving mechanism 36 to arrange it at the second teaching position TP2.

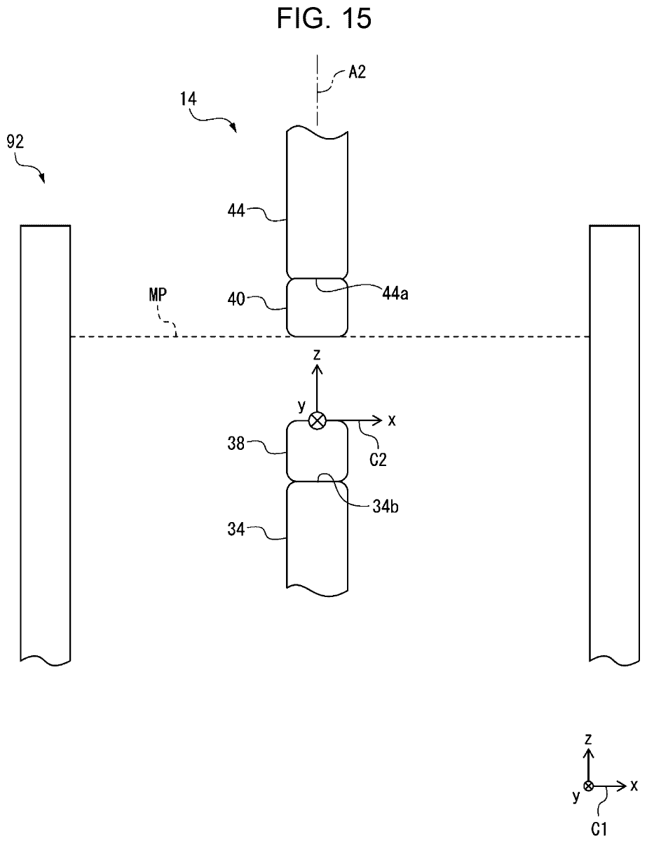

In step S13 in FIG. 6 or 11, the processor 50 determines whether or not the movable welding tip 40 has reached the measurement position MP. More specifically, the processor 50 determines whether or not an object detection signal is received from the object detection sensor 92 (whether or not the object detection signal is turned ON). The movable welding tip 40 is moved downward in step S12 or S32 executed before this step S13, and as a result the movable welding tip 40 reaches the measurement position MP (i.e., the propagation region of the electromagnetic waves) as illustrated in FIG. 15.

Then, the object detection sensor 92 turns ON the object detection signal and transmits it to the control device 16. The processor 50 can determine by monitoring the object detection signal whether or not the movable welding tip 40 has reached the measurement position MP. When the object detection signal is received from the object detection sensor 92, the processor 50 determines it to be YES and proceeds to step S14.

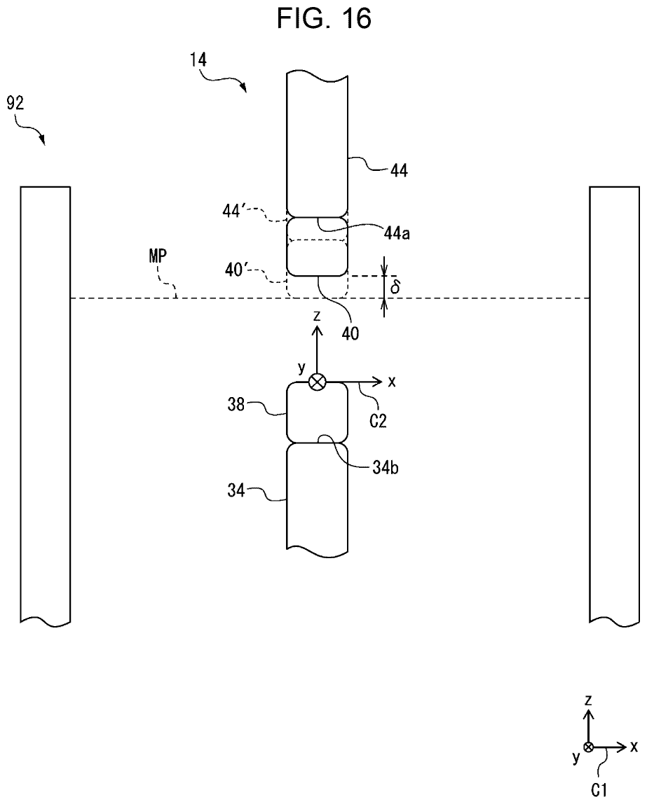

Then, in step S3 or S23, based on the most recently acquired position Pₙ as illustrated in FIG. 16, the processor 50 determines the measurement start position SPₙ as the position of the movable arm 44 at which the movable welding tip 40 is positioned away to the upper side by the distance δ than when the movable arm 44 is arranged at the position Pₙ (the position of the dotted line 40′).

In this manner, in the present embodiment, the processor 50 in the measurement operation MOₙ moves the movable welding tip 40 downward until the object detection sensor 92 detects the movable welding tip 40 at the measurement position MP, and acquires the position Pₙ of the movement machine 58 at the time when the object detection signal is received from the object detection sensor 92 in step S2 or S22. With this configuration, in comparison with the case where the movable welding tip 40 is brought into contact with the above-described fixed member 64, the load applied to the movable welding tip 40 and the tip moving mechanism 36 can be reduced.

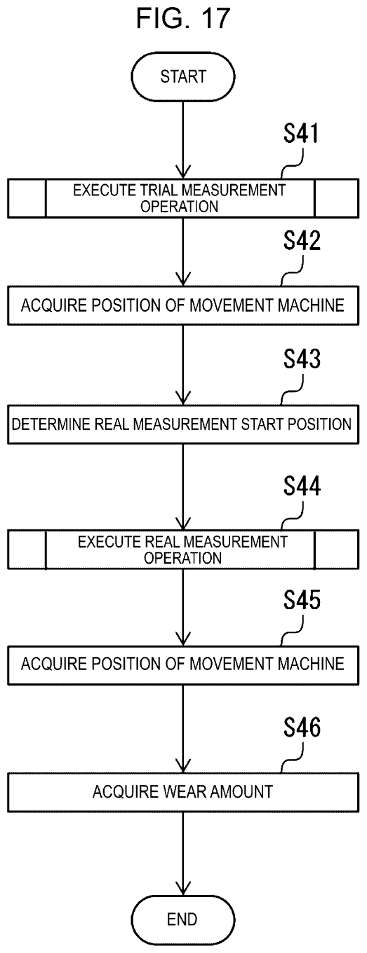

Next, with reference to FIG. 17, another example of a method of measuring the amount of wear W executed by the processor 50 of the robot system 90 is described. The processor 50 of the robot system 90 repeatedly executes the flow illustrated in FIG. 17 each time the above-described measurement start command CM2 is received.

In step S41, the processor 50 functions as the measurement operation execution section 70, and executes an n-th trial measurement operation MO_{T_n}. This step S41 is the same as the flow illustrated in FIG. 6. More specifically, the processor 50 executes the first approach operation in step S11 to position the movement machine 58 at the teaching position TP (FIG. 14), and moves the movable welding tip 40 downward at the speed V1 in step S12. Then, when it is determined to be YES in step S13 (i.e., the object detection signal is received from the object detection sensor 92), the processor 50 stops the movable welding tip 40 in step S14.

In step S42, the processor 50 functions as the position data acquiring section 72, and the movement machine 58 acquires a position P_{T_n} (the rotation position of the servomotor 46) at this time point as a trial measurement position P_{T_n} as in the above-described step S2. Here, variation of the speed V of the movable welding tip 40 may occur at the position of the movable arm 44, due to the delay of the sensor response of the object detection sensor 92 and the like, when the object detection sensor 92 detects the movable welding tip 40 at the measurement position MP and the processor 50 receives the object detection signal.

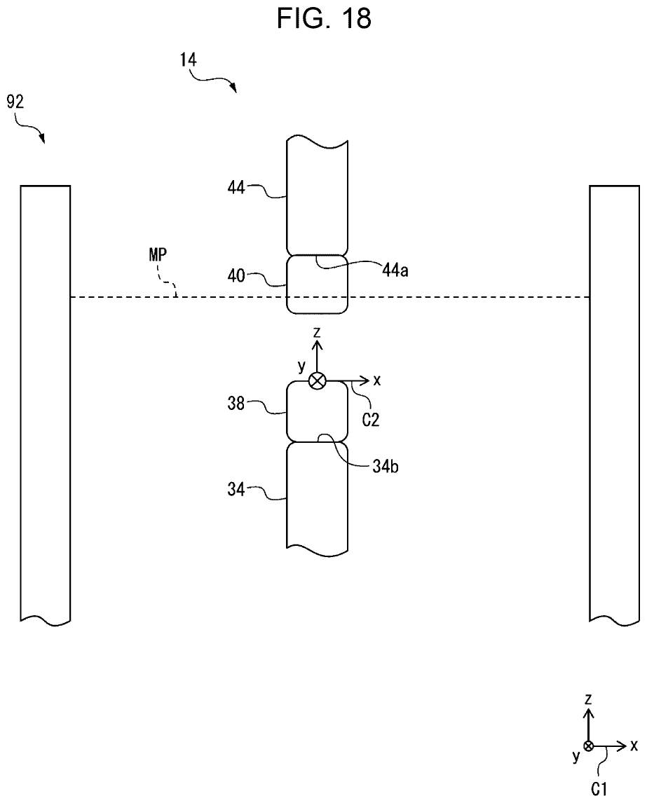

That is, the accuracy of the detection of the movable welding tip 40 by the object detection sensor 92 at the measurement position MP depends on the speed V of the movable welding tip 40 passing through the measurement position MP. FIG. 18 includes an example of the position P_{T_n} of the movable welding tip 40 when it is determined to be YES in step S13 in step S41.

In step S43, the processor 50 functions as the measurement start position determination section 74, and, as in the above-described step S3, determines a real measurement start position SP_{R_n} as the position of the movable arm 44 at which the movable welding tip 40 is positioned away to the upper side by the distance δ than when the movable arm 44 is arranged at the trial measurement position P_{T_n}, whereas the movable welding tip 40 is positioned away to the lower side than when the movable arm 44 is arranged at the second teaching position TP2 based on the trial measurement position P_{T_n} acquired in step S42 (FIG. 14).

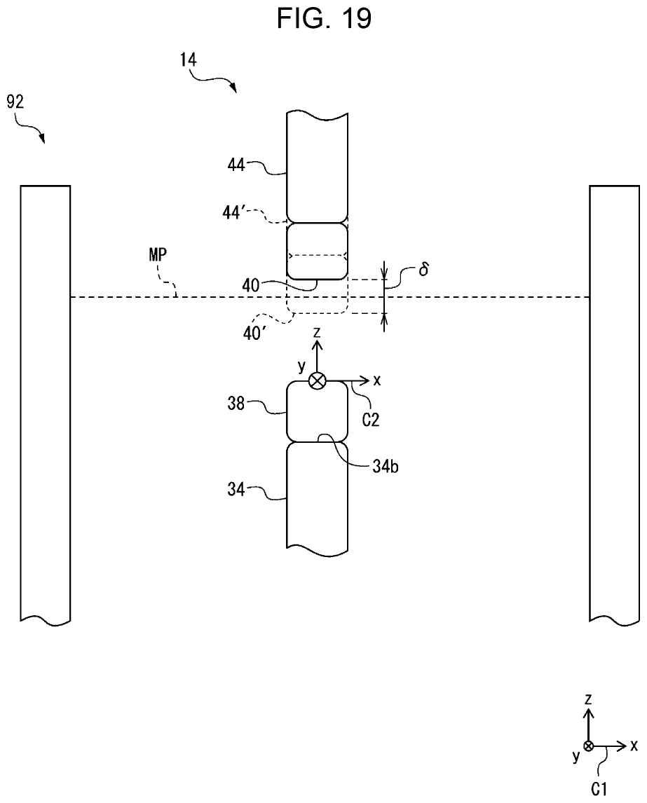

An example of the real measurement start position SP_{R_n} determined at this step S43 is illustrated in FIG. 19. In FIG. 19, the dotted line 44′ indicates the movable arm 44 arranged at the trial measurement position P_{T_n} in step S41, and the dotted line 40′ indicates the movable welding tip 40 when the movable arm 44 is arranged at the trial measurement position P_{T_n}.

On the other hand, the solid line indicates the movable arm 44 arranged at the real measurement start position SP_{R_n}, and the movable welding tip 40 when the movable arm 44 is arranged at the real measurement start position SP_{R_n}. Here, the distance δ is set such that the tip end of the movable welding tip 40 at the real measurement start position SP_{R_n} is positioned away to the upper side from the measurement position MP. For example, the distance δ may be set based on the above-described positioning error α or the approach run distance β.

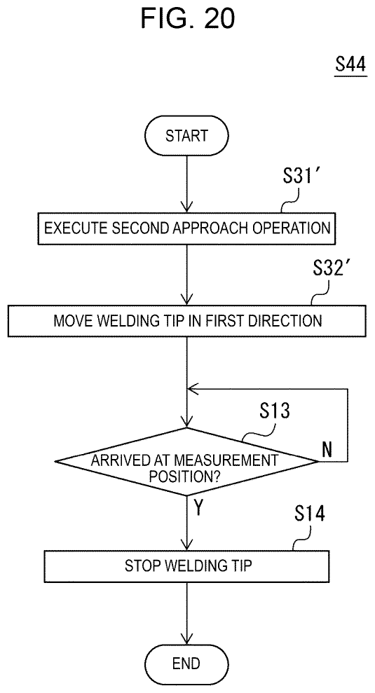

With reference to FIG. 17 again, in step S44, the processor 50 functions as the measurement operation execution section 70, and executes an n-th real measurement operation MO_{R_n}. This step S44 is described with reference to FIG. 20. Note that in the flow illustrated in FIG. 20, the same processes as those of the flow illustrated in FIG. 11 are denoted with the same reference numerals, and overlapping description thereof is omitted.

The processor 50 executes the second approach operation in step S31′ after the start of step S44. Here, at this step S31′, the processor 50 operates the tip moving mechanism 36 to move the movable arm 44 from the position at the completion of step S41 (FIG. 18) to the real measurement start position SP_{R_n} determined in the most recent step S43 (FIG. 19) at the speed V3.

In step S32′, the processor 50 moves the movable welding tip 40 toward the measurement position MP of the object detection sensor 92 in the first direction. More specifically, the processor 50 moves forward the movable arm 44 from the real measurement start position SP_{R_n} at the speed V4 (<V3) by operating the tip moving mechanism 36, thereby moving the movable welding tip 40 downward at the speed V4. Thereafter, the processor 50 sequentially executes steps S13 and S14.

As described above, the accuracy of the detection of the movable welding tip 40 by the object detection sensor 92 at the measurement position MP depends on the speed V. Thus, by moving the movable welding tip 40 at the speed V4 lower than the speed V3 in step S32′, it can be detected with high accuracy that the movable welding tip 40 has reached the measurement position MP.

With reference to FIG. 17 again, in step S45, the processor 50 functions as the position data acquiring section 72, and acquires a position P_{R_n} of the movement machine 58 (more specifically, the movable arm 44) upon completion of step S44 (more specifically, the rotation position of the servomotor 46) as a real measurement position P_{R_n} as at the above-described step S23.

In step S46, the processor 50 functions as the wear amount acquiring section 76, and acquires the amount of wear Wₙ₋₁. More specifically, the processor 50 acquires the amount of wear Wₙ₋₁ caused by the polishing work executed between the n−1th real measurement operation MO_{R_n-1} and the n-th real measurement operation MO_{R_n} based on the real measurement position P_{R_n-1} (third position) acquired when executing the n−1th real measurement operation MO_{R_n-1} and the real measurement position P_{R_n} (second position) acquired when executing the n-th real measurement operation MO_{R_n}.

Note that when the above-described initial measurement start command CM1 is received (i.e., when an unworn new movable welding tip 40 is mounted to the movable arm 44), the processor 50 sequentially executes the flow of steps S41 to S45 in FIG. 17, executes the first trial measurement operation MO_{T_1} (step S41) and a first real measurement operation MO_{R_1} (step S44), and acquires a real measurement position P_{R_1} in step S45.

As described above, in the present embodiment, the processor 50 determines the real measurement start position SP_{R_n} (step 43) based on the trial measurement position P_{T_n} (first position) acquired in the n-th trial measurement operation MO_{T_n}, and moves the movable welding tip 40 downward (first direction) after positioning the movement machine 58 (the movable arm 44) at the real measurement start position SP_{R_n} in the n-th real measurement operation MO_{R_n}. By determining the trial measurement position P_{T_n} appropriately in this manner, the start point of the operation to move the movable welding tip 40 to the measurement position MP at the speed V4 in step S44 can be set as appropriate. As a result, the time required for the measurement of the amount of wear W can be adjusted as appropriate.

In addition, in the present embodiment, the processor 50 moves the movable welding tip 40 at the relatively high speed V1 in the trial measurement operation MO_{T_n}, whereas the processor 50 moves the movable welding tip 40 at the relatively low speed V4 in the real measurement operation MO_{R_n}. With this configuration, the trial measurement position P_{T_n} can be acquired more quickly, while the real measurement position P_{R_n} can be acquired with higher accuracy.

In addition, in the present embodiment, in the first approach operation in step S41 and the second approach operation in step S44, the movable welding tip 40 is moved at the relatively high speeds V1 and V3. With this configuration, the time required for the measurement operation MO (more specifically, the trial measurement operation MO_{T_n}, and the real measurement operation MO_{R_n}) can be reduced. Thus, the work efficiency can be improved by reducing the cycle time of the work.

Note that in step S44 illustrated in FIG. 20, the processor 50 may execute step S11 (the first approach operation) before step S31′. In this case, after the start of step S44, the processor 50 positions the movement machine 58 at the teaching position TP (FIG. 14) in step S11, and then moves the movable arm 44 from the teaching position TP (the second teaching position TP2) to the real measurement start position SP_{R_n} (FIG. 19) in step S31′.

In this case, the processor 50 may once stop the movable arm 44 upon completion of step S31′ (i.e., when the movable arm 44 is arranged at the real measurement start position SP_{R_n}), and then move the movable arm 44 downward in step S32′. Then, the distance δ in FIG. 19 may be set based on the above-described approach run distance β (δ=β, or δ=κβ).

Alternatively, the processor 50 may continuously execute step S32′ without stopping the movable arm 44 upon completion of step S31′. In this case, the distance δ in FIG. 19 may be set based on the above-described approach run distance ε (δ=ε, or δ=κε).

Note that step S23 may be omitted from the flow illustrated in FIG. 10, and, in step S31 in FIG. 11, the processor 50 may position the movement machine 58 at the measurement start position SP₁ determined first in step S3 in FIG. 5. That is, in this case, a common measurement start position SP₁ is used in each measurement operation MOₙ (n=2, 3, 4, . . . ).

In addition, step S11 may be omitted from step S21 illustrated in FIG. 11. In this case, the processor 50 executes the second approach operation of step S31 after the start of step S21, and the processor 50 directly moves the movement machine 58 (the movable arm 44) to the most recently determined measurement start position SPₙ₋₁. At this time, the processor 50 may move the movement machine 58 (the movable arm 44) to the measurement start position SPₙ₋₁ at the speed V1 or V3.

In the above-described embodiment, a case is described in which the processor 50 acquires the rotation position of the servomotor 46 as the position Pₙ of the movement machine 58 in steps S2, S22, S42 and S45. However, the processor 50 may acquire a coordinate CD of the robot coordinate system C1 of the tip end 44a of the movable arm 44 as the position Pₙ of the movement machine 58, for example.

This coordinate CD can be determined based on the position data of the tool coordinate system C2 in the robot coordinate system C1, and the rotation position of the servomotor 46. Note that the position data of the tool coordinate system C2 at the time of executing the measurement operation (i.e., upon completion of steps S1, S21, S41 and S44) can be determined from the rotation position of each servomotor 30 of the robot 12.

In the above-described embodiment, in steps S12, S31, S32, S31′, and S32′, the processor 50 moves the movable arm 44 downward by operating the tip moving mechanism 36. However, the processor 50 may move the welding gun 14 downward by operating the robot 12 in steps S12, S31, S32, S31′ and S32′. In this case, the processor 50 may acquire the above-described coordinate CD as the position Pₙ of the movement machine 58 in steps S2, S22, S42 and S45.

In the above-described embodiment, a case is described in which the processor 50 determines the measurement start positions SPₙ and SP_{R_n} as the position of the movable arm 44 at which the movable welding tip 40 is positioned away to the lower side from the teaching position TP in steps S3, S23 and S43. Specifically, in this case, the measurement start positions SPₙ and SP_{R_n} and the teaching position TP are aligned on the gun axis A2.

However, the processor 50 may determine the measurement start positions SPₙ and SP_{R_n} as the position of the movable arm 44 at which the movable welding tip 40 is positioned away to the left or right side from the teaching position TP, for example. Specifically, in this case, the measurement start positions SPₙ and SP_{R_n} and the teaching position TP are displaced in the direction that intersects the gun axis A2. The processor 50 can move the movement machine 58 (i.e., the movable welding tip 40) from such a teaching position TP to the measurement start positions SPₙ and SP_{R_n} by operating the robot 12.

In the above-described embodiment, a case is described in which the movable welding tip 40 is moved to measure the amount of wear W, but the processor 50 may measure the amount of wear W of the fixed welding tip 38 by executing the flow illustrated in FIG. 5, 10 or 17 by operating the robot 12.

The wear amount acquiring section 76 may be omitted from the device 80. For example, by omitting step S24 from the flow of FIG. 10, the operator may manually determine the amount of wear Wₙ₋₁ by referring to the first position Pₙ₋₁ and the second position Pₙ. In addition, by omitting step S46 from the flow of FIG. 17, the operator may manually determine the amount of wear Wₙ₋₁ by referring to a third position P_{R_n-1} and a second position P_{R_n}.

Alternatively, the function of the wear amount acquiring section 76 may be mounted in an external device (such as an external server that is a computer provided separately from the control device 16) outside the device 80. In this case, by omitting step S24 (or S46), the processor 50 may transmit the acquired first position Pₙ₋₁ and second position Pₙ (or, third position P_{R_n-1} and second position P_{R_n}) to the external device through the network (such as the Internet, or a LAN) and the external device may acquire the amount of wear Wₙ₋₁.

In addition, in the above-described embodiment, a case is described in which the function of the device 80 is mounted in the control device 16. However, the function of the device 80 may be mounted in the teaching device 18 or in an external device (such as an external server and a PC) provided communicatively with the control device 16, for example. In this case, the processor of the external device or the teaching device 18 functions as the device 80.

In addition, the robot 12 is not limited to vertical articulated robots, but may be robots of any types, such as horizontal articulated robots and parallel link robots. In addition, in the above-described embodiment, a case is described in which the movement machine 58 includes the robot 12 and the tip moving mechanism 36, but this is not limitative, and the welding tip 38 or 40 may be moved by a plurality of ball screw mechanisms, for example.

In addition, the welding gun 14 is not limited to C-type spot welding guns, and may be X-type spot welding guns, or any other welding guns. Although the present disclosure has been described through embodiments above, the embodiments described above do not limit the scope of the invention claimed in the claims.

### REFERENCE SIGNS LIST

10, 90 Robot system
12 Robot
14 Welding gun
16 Control device
36 Tip moving mechanism
38, 40 Welding tip
58 Movement machine
70 Measurement operation execution section 70
72 Position data acquiring section
74 Measurement start position determination section
76 Wear amount acquiring section

1. A device configured to measure an amount of wear of a welding tip moved by a movement machine, the device comprising:
a measurement operation execution section configured to control the movement machine so as to execute a measurement operation to move the welding tip in a first direction to a predetermined measurement position for measuring the amount of wear;
a position data acquiring section configured to acquire a position of the movement machine when the measurement operation execution section executes the measurement operation; and
a measurement start position determination section configured to, based on a first position acquired by the position data acquiring section in a first measurement operation, determine a position of the movement machine, at which the welding tip is arranged more separate towards a second direction opposite the first direction by a predetermined distance than the first position, as a measurement start position,
wherein the measurement operation execution section controls the movement machine so as to move the welding tip in the first direction after positioning the movement machine at the measurement start position, in a second measurement operation after the first measurement operation.

2. The device of claim 1, further comprising a wear amount acquiring section configured to acquire the amount of wear generated between the first measurement operation and the second measurement operation, based on the first position and a second position acquired by the position data acquiring section in the second measurement operation.

3. The device of claim 1, wherein a fixed member or a sensor configured to detect the welding tip is provided at the measurement position,
wherein, in the measurement operation, the measurement operation execution section moves the welding tip in the first direction until the welding tip contacts the fixed member at the measurement position, or until the sensor detects the welding tip at the measurement position.

4. The device of claim 1, further comprising a wear amount acquiring section configured to, based on a second position acquired by the position data acquiring section in the second measurement operation and a third position acquired by the position data acquiring section in a third measurement operation before the first measurement operation, acquire the amount of wear generated between the second measurement operation and the third measurement operation.

5. The device of claim 4, wherein a sensor configured to detect the welding tip is provided at the measurement position,
wherein, in the measurement operation, the measurement operation execution section moves the welding tip in the first direction until the sensor detects the welding tip at the measurement position.

6. The device of claim 1, wherein, in the second measurement operation, the measurement operation execution section controls the movement machine so as to position the movement machine at the measurement start position after positioning the movement machine at a predetermined teaching position.

7. The device of claim 6, wherein the measurement start position determination section determines the measurement start position as a position of the movement machine, at which the welding tip is arranged more separate towards the first direction than the teaching position.

8. The device of claim 6, wherein, in the first measurement operation, the measurement operation execution section controls the movement machine so as to move the welding tip in the first direction after positioning the movement machine at the teaching position.

9. The device of claim 1, wherein, in the second measurement operation, the measurement operation execution section moves the movement machine to the measurement start position at a first speed, and moves the movement machine from the measurement start position in the first direction at a second speed lower than the first speed.

10. A control device comprising the device of claim 1, wherein the control device executes a work to move the welding tip by the movement machine and weld a workpiece by the welding tip.

11. A robot system comprising:
a movement machine configured to move a welding tip; and
the control device of claim 10, configured to control the movement machine.

12. A method of measuring an amount of wear of a welding tip moved by a movement machine, the method comprising:
controlling, by a processor, the movement machine so as to execute a measurement operation to move the welding tip in a first direction to a predetermined measurement position for measuring the amount of wear;
acquiring, by the processor, a position of the movement machine when executing the measurement operation;
based on a first position acquired in a first measurement operation, determining, by the processor, a position of the movement machine, at which the welding tip is arranged more separate towards a second direction opposite the first direction than the first position, as a measurement start position; and
controlling, by the processor, the movement machine so as to move the welding tip in the first direction after positioning the movement machine at the measurement start position, in a second measurement operation after the first measurement operation.

13. A computer-readable recording medium configured to store a computer program configured to cause the processor to execute the method of claim 12.
